(19) United States
(12) Patent Application Publication
(10) Pub. No.: US 2010/0329088 A1
(43) Pub. Date: Dec. 30, 2010

(54) DEVICE FOR DETERMINING EXISTENCE OF WOBBLE, MEDIUM DISCRIMINATION DEVICE, METHOD OF DETERMINING EXISTENCE OF WOBBLE, AND MEDIUM DISCRIMINATION METHOD

(76) Inventor: Kinji Kayanuma, Tokyo (JP)

Correspondence Address: Mr. Jackson Chen, 6535 N. STATE HWY 161, IRVING, TX, 75039, US

(21) Appl. No.: 12/865,195

(22) PCT Filed: Jan. 30, 2009
(86) PCT No.: PCT/JP2009/052003

§ 371 Date: Aug. 2, 2010

(30) Foreign Application Priority Data
Feb. 6, 2008 (JP) 2008-025875 2008

(51) Int. Cl. G11B 7/007

(52) U.S. Cl. 369/44.13; G9B/7.029

(57) ABSTRACT

The invention device has amplitude correction means for generating, from a radial push-pull signal, a wobble signal which has been corrected such that the amplitude of a predetermined frequency component is kept substantially constant, and for outputting a magnification for correcting the amplitude of the predetermined frequency component as a gain control signal, and determination means for determining whether or not wobble exists based on a minimum value of the magnification indicated by the gain control signal.

### TECHNICAL FIELD

This invention relates to a device and a method for determining existence or non-existence of wobble which determines whether or not a meandering recording track is provided on a storage medium based on a radial push-pull signal, and also relates to a medium discrimination device and method for discriminating types of optical discs.

### BACKGROUND ART

There exist several different standards for optical discs represented by DVDs (Digital Video Discs) and next-generation DVDs, specifying different physical formats and record reproduction conditions. In order to allow optical discs according to these different standards to be recorded and reproduced by a single optical disc device, it is necessary to determine the type of the optical disc loaded into the optical disc device.

Various methods of discriminating the media according to these different standards have been studied and disclosed in patent documents. Japanese Laid-Open Patent Publication No. 2000-149392, for example, discloses a method of determining the type of a medium based on the quantity and amplitude of S-curves contained in a focus error signal output when an optical pick-up is moved perpendicularly to the recording surface of an optical disc. However, there exists a plurality of standards for DVDs which do not involve differences in quantity or amplitude of S-curves. Therefore, the criteria of quantity and amplitude of S-curves are not enough to discriminate the media.

Japanese Laid-Open Patent Publication No. 2002-230753 discloses a method of determining a type of a disc by extracting a clock signal from a wobble signal indicating a wobbling component in recording tracks, and measuring the frequency of the extracted clock signal. The use of this method enables discrimination of optical discs having different meander frequencies of the recording tracks. However, the wobble signal from which the clock signal is to be extracted can be only obtained by performing tracking servo control to control the position such that a collected light beam follows the recording track.

The procedures of determination become complicated if optical discs to be discriminated include both recordable media having recording tracks formed by meandering grooves, and read-only media having recording tracks formed by embossed pits. A phase contrast method is generally used for tracking servo control in the read-only media, and sufficient stability cannot be obtained by such control using a radial push-pull signal. Therefore, the discrimination between read-only media and recordable media must be performed prior to performing the tracking servo control. Consequently, the method of extracting a clock signal from a wobble signal after performing the tracking servo control is not suitable for discrimination of the optical discs in which read-only media are included.

Japanese Laid-Open Patent Publication No. 2004-055079 discloses a method of determining the type of a storage medium by using a radial push-pull signal prior to performing tracking servo control. This method uses a digitized radial push-pull signal to determine whether or not a component corresponding to wobble cycle is contained based on a result obtained for autocorrelation. According to this method, correlation is not found in relation to wobble cycle of any type of read-only media having no meandering recording tracks, whereas in media having meandering recording tracks, an autocorrelation component is found corresponding to their wobble cycles, whereby the types of the storage media can be determined. Accordingly, even if read-only media are mixed, the types of media can discriminated based on existence or non-existence of autocorrelation, or the magnitude of autocorrelation corresponding to the wobble cycle.

FIG. 6 is a block diagram showing of an optical disc reproduction device using a method of determining whether or not wobble exists by obtaining autocorrelation. A head 2 outputs a signal obtained from reflected light from an optical disc 1 and a radial push-pull signal amplified by a reproduction amplifier 3 is output. A wobble signal detection circuit 17 operates to determine whether or not a wobble component exists based on the output from the regenerative signal amplifier.

A signal given to the wobble signal detection circuit 17 is digitized by a high-pass filter 12 and a digitizing circuit 13 and fed to an autocorrelation computing circuit 14. The autocorrelation computing circuit computes autocorrelation of the digitized signal input thereto, based on a control signal sent from a timing control circuit 16. Using a signal obtained by delaying the digitized signal by approximately a half cycle of the wobble, the autocorrelation is computed as a proportion of a period of time during which signals before and after the delaying assume different values, with respect to a certain period of time specified by the timing control circuit.

If a radial push-pull signal contains a reference wobble frequency component, the value of the autocorrelation will become greater. However, when no tracking control is performed, the radial push-pull signal does not always contain a reference wobble frequency component. A maximum value holding circuit 15 holds a maximum value of the autocorrelation output from the autocorrelation circuit, and determines that a wobble component exists when this maximum value exceeds a certain threshold. After the determination result is read by a disc system control circuit 8, the maximum value that has been held is initialized by means of the timing control circuit.

Further, a method of detecting wobble is disclosed by Japanese Laid-Open Patent Publication No. 2004-310920 disclosing a wobble detection device wherein a wobble signal is extracted from a radial push-pull signal and the signal amplitude is used as a gain setting signal. Further, Japanese Laid-Open Patent Publication No. H09-326122 discloses a technique to extract a wobble signal by feeding back a signal sampled when a read-out signal is at a high level as a control signal for a variable amplification circuit. Japanese Laid-Open Patent Publication No. 2003-338041 discloses a technique to extract a wobble signal by feeding back a gain control signal to a variable gain amplifier in order to control the amplitude of a read-out signal at a constant level. Further, Japanese Laid-Open Patent Publication No. 2005-346881 discloses a technique to extract a wobble signal with the use of a bandpass filter in which the pass band is varied by means of a frequency signal from a frequency extraction circuit which generates a frequency signal from a read-out signal input thereto. However, these patent documents are different in configuration from that of this invention, and have problems that a wobble signal may be discontinued, and it is difficult to determine whether a wobble signal exists or not when the variation in amplitude is large.

### DISCLOSURE OF THE INVENTION

### Problems to be Solved by the Invention

According to the method using autocorrelation disclosed in Japanese Laid-Open Patent Publication No. 2004-055079A, it is possible to determine whether or not a component corresponding to a wobble cycle is contained in a radial push-pull signal without performing tracking servo control.

However, this method has drawbacks as follows. The autocorrelation is computed by using a digitized radial push-pull signal and integrating the frequency in which signals before and after the delaying by a period corresponding to a half cycle of wobble assume different values. Therefore, correlation as high as that of the original wobble cycle is obtained for a cycle corresponding to ⅓ or ⅕ of the original. This means that, if there exist storage media according to different standards having triple and quintuple meander frequencies, these media may possibly be discriminated erroneously. Further, since the frequency resolution of the autocorrelation computation is low, there is another drawback that when there exist two different types of media having meander frequencies close to each other, it is difficult to find difference in magnitude of autocorrelation and to discriminate these two from each other.

It is therefore an object of this invention to provide a device for determining existence and non-existence of wobble, a medium discrimination device, a method for determining existence and non-existence of wobble, and a medium discrimination method, which are capable of rapid and reliable discrimination of several different media manufactured according to different standards for optical discs.

### Means for Solving the Problems

In order to solve the problems as described above, the invention of this application provides a device for determining existence or non-existence of wobble, which determines whether or not an information track of an optical disc meanders at a predetermined frequency based on a radial push-pull signal. The device is characterized by including: amplitude correction means for generating, from the radial push-pull signal, a wobble signal which has been corrected such that the amplitude of a predetermined frequency component is kept substantially constant, and for outputting a magnification for correcting the amplitude of the predetermined frequency component as a gain control signal; and determination means for determining whether or not wobble exists based on the minimum value of the magnification indicated by the gain control signal.

The invention of this application also provides a medium discrimination device for discriminating types of optical discs based on a radial push-pull signal. The medium discrimination device is characterized by including: reference frequency information generation means for switching and outputting reference wobble frequency information according to several different standards; amplitude correction means for generating, from the radial push-pull signal, a wobble signal which has been corrected such that the amplitude of a frequency component designated by the reference wobble frequency information is kept substantially constant, and for outputting a magnification for correcting the amplitude of the designated frequency component, as a gain control signal; and discrimination means for discriminating types of media based a plurality of minimum values of the gain control signals obtained for a plurality of pieces of reference wobble frequency information supplied by the reference frequency information generation means.

The invention of this application also provides a method of determining existence or non-existence of wobble, which determines whether or not an information track of an optical disc meanders at a predetermined frequency based on a radial push-pull signal. The method is characterized by including the steps of generating a wobble signal by correcting the amplitude of the radial push-pull signal based on a gain control signal and extracting a predetermined frequency component; generating a gain control signal indicating such a correction magnification as to keep the amplitude of the wobble signal substantially constant; and determining existence or non-existence wobble, based on the minimum value of the magnification indicated by the gain control signal.

The invention of this application also provides a medium discrimination method for discriminating types of optical discs based on a radial push-pull signal. The medium discrimination method is characterized by including the steps of: generating reference frequency information by switching and outputting pieces of reference wobble frequency information according to a plurality of standards; generating a wobble signal from the radial push-pull signal by correcting the amplitude of a frequency component designated by the reference wobble frequency information to be kept substantially constant, and extracting the designated frequency component; generating a gain control signal indicating such a correction magnification as to keep the amplitude of the wobble signal substantially constant; and determining the type of the medium based on a plurality of minimum values of gain control signals obtained in correspondence with a plurality of pieces of reference frequency information.

### Advantageous Effects of the Invention

According to this invention, a wobble signal is generated from a radial push-pull signal, and a magnification for correcting the amplitude of a predetermined frequency component is used as a gain control signal. It is made possible to determine whether or not wobble exists by using the minimum value of this gain control signal. Further, it is made possible to discriminate the media on the basis of a plurality of minimum values of the gain control signals for a plurality of reference wobble frequencies. According to this invention, the use of the minimum values of the gain control signals makes it possible to obtain a wobble detecting device, a medium discrimination device, a wobble detecting method, and a medium discrimination method for realizing rapid and reliable discrimination.

### BRIEF DESCRIPTION OF THE DRAWINGS

FIG. 1 is a block diagram showing an optical disc reproduction device according to a first embodiment of this invention;

FIG. 2 is a waveform diagram for explaining operation of the optical disc reproduction device to determine existence of non-existence of wobble according to the first embodiment of the invention;

FIG. 3 is a block diagram of a gain control circuit according to the first embodiment of the invention;

FIG. 4 is a block diagram of an optical disc reproduction storage device according to a second embodiment of the invention;

FIG. 5 is a block diagram of an optical disc reproduction storage device according to a third embodiment of the invention; and

FIG. 6 is a block diagram of an optical disc reproduction device according to Japanese Laid-Open Patent Publication No. 2004-055079.

### BEST MODE FOR CARRYING OUT THE INVENTION

In order to clarify the above-mentioned and other objects, characteristics and advantages of this invention, exemplary embodiments of this invention will be described in detail with reference to the accompanying drawings.

### First Embodiment

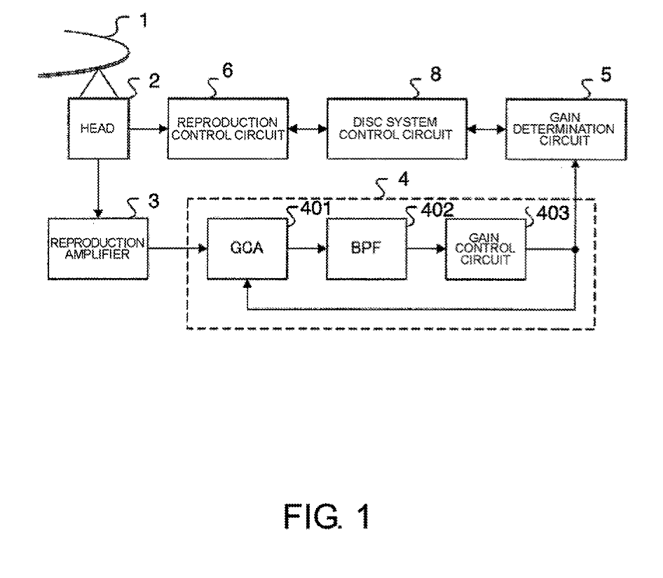

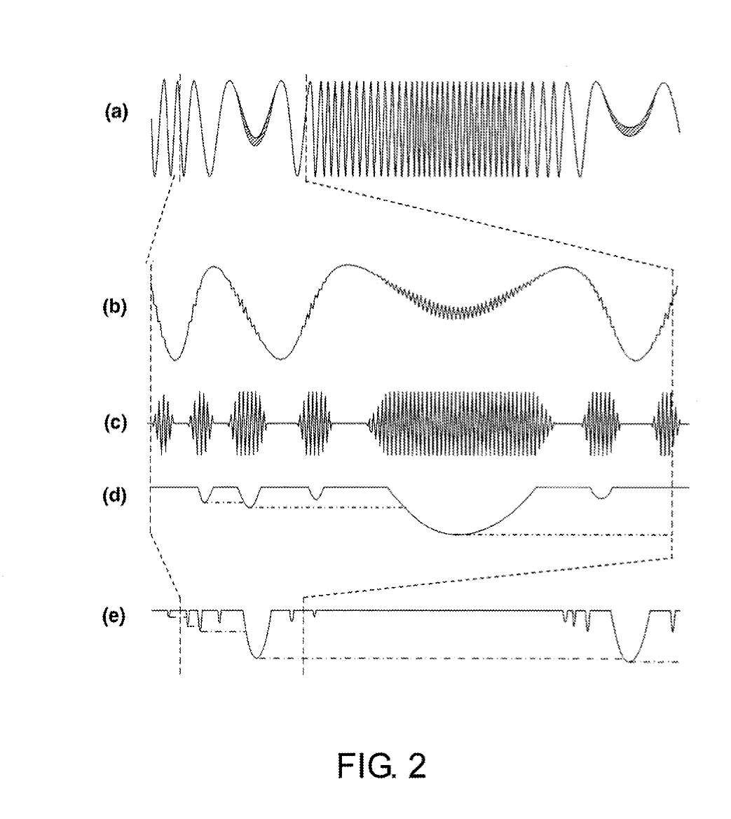

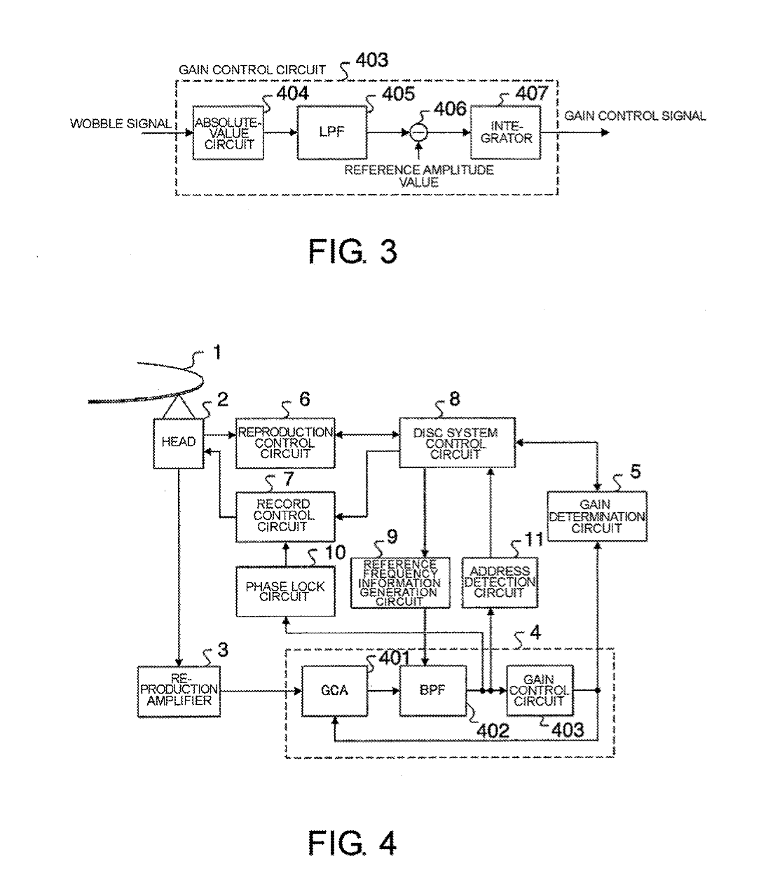

A first embodiment of this invention will be described in detail with reference to FIGS. 1 to 3. This embodiment relates to determination of existence or non-existence of wobble in an optical disc reproduction device. FIG. 1 is a block diagram of an optical disc reproduction device according to the first embodiment of this invention. FIG. 2 is a waveform diagram for explaining operation to determine existence or non-existence of wobble. FIG. 3 is a block diagram of a gain control circuit.

The optical disc reproduction device shown in FIG. 1 is composed of an optical disc 1, a head 2, a reproduction amplifier 3, an amplitude correction circuit 4, a gain determination circuit 5, a reproduction control circuit 6, and a disc system control circuit 8. The configuration of the optical disc reproduction device in FIG. 1 is not shown in FIG. 1 and detailed description thereof will be omitted, since it is well known except for its function relating to determination of existence or non-existence of wobble. The determination of existence or non-existence of wobble is carried out by using the amplitude correction circuit 4 and the gain determination circuit 5. FIG. 2 is a waveform diagram for explaining operation to determine existence or non-existence of wobble, wherein waveforms (a) and (b) are waveforms of a radial push-pull signal from the head 2, waveform (c) is a waveform of wobble from a bandpass filter 402, waveforms (d) and (e) are waveforms of a gain control signal from a gain control circuit 403. The waveforms (b), (c), and (d) in FIG. 2 are represented by enlarging the timing axis within the range indicated by the broken lines.

The optical disc 1 loaded in the optical disc device is rotation-driven by a spindle motor (not shown) such that the rotation speed is held substantially constant. A light beam emitted from the head 2 is reflected by a recording surface of the optical disc 1 and detected by a group of detectors (again not shown) within the head 2. Further, positional deviations in a direction of focal depth and in a direction traversing tracks are detected based on signals output from the group of detectors. The position of an objective lens (not shown) is controlled by using an actuator (not shown) enclosed within the head 2, whereby a function is provided to reproduce data on a desired track.

When determining existence or non-existence of wobble, the position of the objective lens is controlled, based on the positional deviation in the direction of focal depth, such that the light beam is focused on the recording surface. However, tracking control corresponding to the control in the direction traversing the tracks is not performed, but a radial push-pull signal obtained in this state is used. Different methods of obtaining positional deviations are employed between read-only media and recordable media for performing tracking control with the use of a signal output by the group of detectors. The tracking control is not performed because the tracking control cannot always be performed stably until the type of the relevant medium is specified.

When a recordable medium is loaded; a radial push-pull signal obtained from the group of detectors (not shown) within the head 2 is fed to the reproduction amplifier 3, with a waveform as shown in waveform (a) of FIG. 2. The focal point of a light beam which is not tracking-controlled traverses a plurality of tracks as the optical disc rotates due to eccentricity in the disc. Every time the light beam traverses a track, a one-cycle waveform having a substantially sinusoidal shape appears. The duration of the sinusoidal wave cycle becomes shorter as the traversing speed increases.

The movement of the focal point to the track traversing direction is caused by eccentricity. Therefore, although a radial push-pull signal will vary in a short cycle period when the focal point is passing obliquely over tracks, this short-cycle state will not last long. The cycle period becomes longer and the change becomes gradual in a region where the trajectory of the focal point is parallel with the tracks. In the region where the change is gradual, the frequency component caused by wobble will appear to be superposed on the radial push-pull signal, in the same manner as when tracking servo is performed.

On the other hand, in a read-only medium having no meandering recording tracks, a radial push-pull signal has a waveform of a general shape similar to that of waveform (a) shown in FIG. 2, but no specific frequency component corresponding to wobble is superposed on the radial push-pull signal. Generally high frequency components are superposed, due to data recorded by an embossed pit row.

Waveform (b) in FIG. 2 shows an enlarged waveform of a radial push-pull signal which may be observed in a recordable medium when a track traversing cycle period is longer. The optical disc reproduction device shown in FIG. 1 is provided therein with a device for determining existence/non-existence of wobble, which is composed of an amplitude correction circuit 4 and a gain determination circuit 5. The device has a function to determine, based on an input radial push-pull signal, whether or not the input radial push-pull signal contains a reference wobble frequency component intrinsic to the medium.

The reproduction amplifier 3 amplifies a radial push-pull signal output from the head and as represented by the waveform (a) and the waveform (b) in FIG. 2, and supplies the amplified signal to the amplitude correction circuit 4. The amplitude correction circuit 4 is composed of a gain control amplifier (GCA) 401, a bandpass filter (BPF) 402, and a gain control circuit 403. The gain control amplifier (GCA) 401 corrects the amplitude of the input radial push-pull signal based on a gain control signal. The bandpass filter (BPF) 402 extracts the predetermined frequency component from a signal output from the gain control amplifier and generates a wobble signal. The gain control circuit 403 generates a gain control signal based on the wobble signal.

The amplitude correction circuit 4 further amplifies the amplified radial push-pull signal by means of the gain control amplifier (GCA) 401, and extracts only a frequency component corresponding to wobble by means of the bandpass filter (BPF) 402. Thus, the components the amplitude of which varies gradually as the light beam traverses the tracks are removed, and the output of the bandpass filter 402 becomes a signal, as represented by the waveform (c) in FIG. 2, in which only the frequency component corresponding to wobble appears intermittently. The wobble component becomes greater when the focal point of the light beam is on a recording track, and becomes smaller when it is passing between the recording tracks.

The gain control circuit 403 detects a signal amplitude output from the bandpass filter 402, and outputs a gain control signal for adjusting the gain of the gain control amplifier 401.

Waveform (d) in FIG. 2 shows variation in the gain control signal. When the radial push-pull signal contains no frequency component corresponding to wobble, the output from the bandpass filter becomes small, while the gain control signal reaches its maximum value. Once a reference wobble frequency component starts appearing in the radial push-pull signal, the amplitude of the signal output from the bandpass filter becomes gradually greater. Once the amplitude has reached a predetermined fixed value, the gain control signal becomes smaller so that the amplitude of the signal output from the bandpass filter is kept constant.

The gain control signal corresponding to the radial push-pull signal before the enlargement of the timing axis (waveform (a) in FIG. 2) is shown in waveform (e) in FIG. 2. When the radial push-pull signal is largely superposed with a component caused by wobble, the gain control signal assumes a small value.

The output of the bandpass filter 402 becomes a signal in which the frequency component corresponding to wobble appears intermittently, and hence the period for which the gain control signal assumes a small value does not last long. The minimum value of the gain control signal serves as an index to indicate whether or not a wobble component is contained. Therefore, the gain determination circuit 5 holds the minimum value and determines whether or not wobble exists on the basis thereof. The dash-dot line in the waveform (e) of FIG. 2 indicates the minimum value held by the gain determination circuit. When the held value is lower than a predetermined fixed value, the gain determination circuit determines that wobble exists.

If wobble exists, the gain control signal will often assume its minimum value when the amplitude of the radial push-pull signal varies gradually. The gradual variation in amplitude of the push-pull signal appears synchronously with rotation of the optical disc. Accordingly, determination errors can be prevented by holding the minimum value of the gain control signal during several rotations of the optical disc, and then making determination based on the minimum value. If the recording track is meandering, the reference wobble frequency component will appear in the radial push-pull signal during the several rotations of the disc, and the minimum value will be smaller than the threshold. In contrast, in an optical disc such as a read-only medium in which no recording track is meandering, the minimum value of the gain control signal will never become smaller than the threshold even after several rotations of the disc.

The disc system control circuit 8 receives the result of determination of existence or non-existence of wobble from the gain determination circuit, and determines the type of the disc. The disc system control circuit 8 then performs tracking control. Further, data reproduction processing is implemented by means of the reproduction control circuit 6.

The description of the example above has been made in terms of a case in which a reference wobble frequency component is detected without performing tracking control. However, it is possible to determine whether or not wobble exists with the use of the circuit according to this embodiment of the invention, also when tracking control is performed using a radial push-pull signal. For example, even in the case of a read-only medium, if it is known that a radial push-pull signal sufficient to enable tracking control can be obtained, the existence or non-existence of wobble may be determined after performing the tracking control. In this case, the reference wobble frequency component will not appear intermittently in the radial push-pull signal. In a recordable medium, a sinusoidal wobble signal having substantially fixed amplitude is obtained, and a gain control signal also assumes a substantially fixed value. In a read-only medium, in contrast, since no wobble component is contained, the gain control signal continues to show a large magnification. The gain determination circuit is able to determine existence or non-existence of a wobble component based on whether the minimum values of the gain signal and gain control signal are less than a certain value.

The gain control amplifier shown in the first embodiment can be formed, for example, by a multiplier varying the magnification by means of a gain control signal. In this case, the magnification varies in proportion to the gain control signal. However, the magnification need not necessarily be in proportion to the gain control signal. The gain control amplifier can be formed by a tranceconductance amplifier in which the magnification varies exponentially to the gain control signal. In this case, the effective range of magnification can be set greater.

FIG. 3 shows a configuration example of the gain control circuit 403. An absolute-value circuit 404 computes an absolute value of a wobble signal input thereto and outputs the computed absolute value. Further, a low-pass filter (LPF) 405 extracts an average value. An output signal from the low-pass filter serves as a signal indicating the magnitude of amplitude of the wobble signal. Further, a subtractor 406 subtracts this from a reference amplitude value, whereby a signal can be obtained, which has a negative value for a wobble signal with an amplitude greater than the reference value, and has a positive value for a wobble signal with an amplitude smaller than the reference value. This can be integrated by an integrator 407 to obtain a gain control signal.

A closed loop is formed by controlling the magnification of the gain control amplifier 401 with the use of the gain control signal. It will be sufficient if the loop bandwidth is set to about 1/100 of the reference wobble frequency. If the loop bandwidth is low, a delay will occur in the response of the gain control signal when variation occurs in amplitude of the wobble signal. However, the period of time for which the reference wobble frequency component is superposed when the variation in amplitude of the radial push-pull signal is gentle is sufficiently longer than this, and hence the delay in response of the gain control signal will not affect the determination.

Although an example is shown in FIG. 3 in which an absolute-value circuit is used to obtain a signal which is proportional to the amplitude of the wobble signal, this may be substituted by a maximum value detection circuit which is designed to output a maximum value every time period corresponding to several wobbles or so. The maximum value detection circuit is susceptible to effects of disturbance, but the circuit itself becomes simpler. Alternatively, instead of the absolute-value circuit, an effective value computing circuit may be used, which outputs an effective value based on a mean square every time period corresponding to several wobbles or so. Since an input wobble signal has a sinusoidal waveform, the use of the effective value computing circuit can further decrease the effects of disturbance.

When no frequency component corresponding to wobble is contained in an input wobble signal, a signal output from the low-pass filter remains in a state having an amplitude smaller than the reference amplitude value, and hence a signal having a positive value is always input to the integrator. Even in such a case, the output of the integrator is saturated upon reaching a certain value, and acts to maintain a maximum gain. It is also possible to set conditions under which the integrator is saturated so as to agree with the maximum gain allowed to the gain control amplifier.

In the first embodiment, the gain determination circuit 5 holds the minimum value of the gain control signal, which is compared with a predetermined fixed value, and it is determined that wobble exists when the minimum value is smaller than the predetermined fixed value. However, the gain determination circuit may be designed to detect that an input gain signal becomes lower than a predetermined threshold without holding the minimum value and to output a signal indicating that a wobble component has been detected.

For example, an optical disc reproduction device handling only read-only DVD-ROMs and recordable DVD-Rs or DVD-RWs is capable of distinguishing between recordable media and read-only media only based on whether or not a wobble component having a single frequency exists. In this case, as described regarding the first embodiment, determination of the gain can be performed based on a signal obtained through a bandpass filter having a specific passband. However, if there mixedly exist media of several different standards having different reference wobble frequencies, it is necessary, in order to discriminate the types of discs, to determine for each of several reference wobble frequency candidates, whether or not a wobble component exists.

This embodiment provides a device for determining existence and non-existence of wobble, having amplitude correction means for generating from a radial push-pull signal a wobble signal which is corrected such that the amplitude of a predetermined frequency component is kept substantially constant, and for outputting, as a gain control signal, a magnification for correcting the amplitude of the predetermined frequency component, and determination means for determining whether or not wobble exists based on a minimum value of the magnification indicated by the gain control signal.

The amplitude correction means of this wobble detecting device can be composed of a gain control amplifier for correcting the amplitude of a radial push-pull signal based on a gain control signal, a bandpass filter for generating a wobble signal by extracting the predetermined frequency component from an output signal of the gain control amplifier, and gain control means for generating a gain control signal based on the wobble signal. Further, the determination means of the device for determining existence and non-existence of wobble may determine whether or not wobble exists by comparing the minimum value of the gain control signal with a predetermined reference value.

This embodiment also provides a method of determining existence or non-existence of wobble including the step of correcting the amplitude of a radial push-pull signal based on a gain control signal, extracting a predetermined frequency component and generating a wobble signal, the step of generating a gain control signal which is a correcting magnification to keep the amplitude of the wobble signal substantially constant, and the step of determining whether or not wobble exists based on the minimum value of magnification indicated by the gain control signal. In this step of determining whether or not exists, it is possible to determine whether not wobble exists by comparing the minimum value of the gain control signal with a predetermined reference value.

Thus, this embodiment provides a device and method for determining existence or non-existence of wobble, which is capable of rapid and reliable determination based on a minimum value of a gain control signal.

### Second Embodiment

A second embodiment of this invention will be described in detail with reference to FIG. 4. This embodiment is an embodiment for discriminating types of media of several different standards having different reference wobble frequencies. FIG. 4 is a block diagram showing an optical disc recording/reproduction device having therein a medium discrimination device according to the second embodiment of the invention. Comparing with the optical disc reproduction device of FIG. 1, the optical disc recording/reproduction device of FIG. 4 further includes a memory control circuit 7, a reference frequency information generation circuit 9, a phase lock circuit 10, and an address detection circuit 11. The other configuration features are the same as those of the first embodiment, and detail description thereof will be omitted.

Operation of the optical disc 1, the head 2 and the reproduction amplifier 3 is the same as in the first embodiment. A radial push-pull signal amplified by the reproduction amplifier 3 is supplied to the amplitude correction circuit 4. The amplitude correction circuit 4 has functions to extract a frequency component for each of a plurality of reference wobble frequency candidates designated by the reference frequency information generation circuit 9, and to output such a gain control signal as to keep the amplitude constant.

The amplitude correction circuit 4 has the same configuration as that in the first embodiment, and is composed of a gain control amplifier (GCA) 401, a bandpass filter (BPF) 402, and a gain control circuit 403. The gain control amplifier (GCA) 401 corrects the amplitude of the radial push-pull signal input thereto, based on a gain control signal. The bandpass filter (BPF) 402 generates a wobble signal by extracting the predetermined frequency component from an output signal from the gain control amplifier. The bandpass filter 402 is supplied with reference frequency information, changes the frequency band to pass through to the frequency of the reference frequency information, and outputs its output also to the phase lock circuit 10 and the address detection circuit 11. The gain control circuit 403 generates a gain control signal, based on a wobble signal.

The disc system control circuit 8 outputs a control signal to the reference frequency information generation circuit 9 to instruct the same to select a first candidate from among a plurality of reference wobble frequency candidates. Receiving this control signal, the reference frequency information generation circuit 9 outputs reference wobble frequency information corresponding to the first candidate to the bandpass filter 402. The gain control amplifier 401 amplifies the signal based on the gain control signal in the same manner as in the first embodiment, whereas the bandpass filter 402 functions to extract a reference wobble frequency component of the first candidate, using frequencies based on the reference frequency information as the pass band.

The bandpass filter may be formed by an IIR (Infinite Impulse Response) filter, for example. The pass band can be realized by changing the gain of each tap within the filter based on the reference frequency information. Alternatively, a similar result can be obtained by changing the computation speed of the filter based on the reference frequency information.

If the reference wobble frequency candidate coincides with the wobble frequency of recording tracks of the optical disc, operation will be the same as in the first embodiment. When it coincides with the wobble frequency, the reference wobble frequency component in a radial push-pull signal is output from the bandpass filter, and a region appears in which the gain control signal output from the gain control circuit 403 assumes a small value. In contrast, when it does not coincide with the wobble frequency, the gain control signal continues remaining at a large value.

The gain determination circuit 5 holds the minimum value of the gain control signal, and determines that wobble of the corresponding frequency exists when the minimum value becomes lower than the threshold. The disc system control circuit 8 receives the result of determination of existence or non-existence of wobble from the gain determination circuit, and determines the type of the disc. Accordingly, the gain determination circuit 5 and the disc system control circuit 8 serve as medium discriminating means.

After determining whether or not a wobble component exists for the first reference wobble frequency candidate, the disc system control circuit outputs a control signal to the reference frequency information generation circuit to instruct the same to select a second candidate, and at the same time initializes the minimum value held in the gain determination circuit. In this manner, determination is performed consecutively for each of the plurality of reference wobble frequency candidates.

Frequency selectivity of the wobble component is determined by passing characteristics of the bandpass filter. The pass band can be set to a range of about ±5% around the center frequency, so that wobble component can be correctly detected even if a deviation of ±5% exists in rotation speed. On the other hand, components having a frequency differing by ±5% or more can be separated. Therefore, even if there are several different standards having reference wobble frequencies which are close to each other, for example, they can be discriminated correctly if the frequencies differ from each other by ±5% or more. False recognition with a triple or quintuple reference wobble frequency can also be avoided.

The consecutive determinations are performed on the plurality of reference wobble frequency candidates, and if it is determined that there exists a specific reference wobble frequency component, tracking control is performed on the relevant medium which is determined to be a recordable medium. For a recordable medium, the recording data rate is determined based on the reference wobble frequency. Additionally, information such as an address or the like is often embedded as an irregular pattern in the wobble frequency or phase.

Under the conditions where the tracking control is active, the amplitude correction circuit 4 constantly outputs a wobble signal having substantially fixed amplitude. This signal is used also for controlling the recording data rate and for allowing the address detection circuit to operate stably. An output signal of the bandpass filter 402 is input to the phase lock circuit 10, and a recording data rate control signal is generated in synchronization with the reference wobble frequency component. The address detection circuit 11 extracts information such as address from the output signal of the bandpass filter 402. The disc system control circuit 8 determines a recording position based on the extracted, address information, and starts sending the recording data to the record control circuit 7. The record control circuit 7 is allowed to correctly record the data on the optical disc by sending the record signal to the head 2 in synchronization with the recording data rate control signal.

Herein, an example has been described in which the gain determination circuit 5 compares a minimum value of the gain control signal with a fixed threshold. However, this threshold can be updated. The smaller minimum value of the gain control signal indicates that the set reference wobble frequency candidate has a greater signal component. Accordingly, a more precise discrimination result can be obtained by comparing the minimum values of the gain control signals obtained for a plurality of reference wobble frequency candidates. For example, when the gain determination circuit detects a gain control signal the minimum value of which is less than a predetermined threshold, the minimum value thus detected is set as a new threshold. Then subsequent consecutive determinations can be conducted on the other reference wobble frequency candidates, using this newly set threshold, so that a reference wobble frequency candidate from which a gain control signal the minimum value of which is the smallest can be identified. The erroneous determination can be avoided by discriminating the media based on this result.

This second embodiment provides a medium discrimination device having information generation means for switching and outputting reference wobble frequency information according to a plurality of different standards, amplitude correction means for generating, from a radial push-pull signal, a wobble signal which has been corrected to keep substantially constant the amplitude of a frequency component designated by the reference wobble frequency information, and for outputting the magnification of the amplitude of the designated frequency component as a gain control signal, and discrimination means for determining the type of the medium based on a plurality of minimum values of gain control signals obtained for a plurality of pieces of reference wobble frequency information supplied by the reference frequency information generation means.

The amplitude correction means of the medium discrimination device may be composed of a gain control amplifier for correcting the amplitude of a radial push-pull signal based on a gain control signal, a bandpass filter for generating a wobble signal by extracting a predetermined frequency component from an output signal from the gain control amplifier, and gain control means for generating a gain control signal based on the wobble signal. Additionally, the discrimination means of the medium discrimination device is capable of determining the type of a medium based on a result of comparing, with respectively predetermined reference values, the plurality of minimum values of the gain control signals obtained in correspondence with the plurality of pieces of reference wobble frequency information. Further, the discrimination means may be designed to determine the type of a medium based on a result of mutually comparing the plurality of minimum values of the gain control signals obtained in correspondence with the plurality of pieces of reference wobble frequency information.

This embodiment of the invention further provides a medium discrimination method including the step of generating reference frequency information by switching and outputting pieces of reference wobble frequency information according to a plurality of standards, the step of generating a wobble signal from the radial push-pull signal by correcting the same such that the amplitude of a frequency component designated by the reference wobble frequency information is kept substantially constant, and extracting the designated frequency component, the step of generating a gain control signal indicating such a correction magnification as to keep the amplitude of the wobble signal substantially constant, and the step of determining the type of a medium based on a plurality of minimum values of gain control signals obtained in correspondence with a plurality of pieces of reference frequency information.

In the step of determining the type of a medium in the medium discrimination method, the type of the medium can be determined based on a result of comparing a plurality of minimum values of gain control signals obtained in correspondence a plurality of pieces of reference wobble frequency information, with respectively predetermined reference values. Alternatively, the medium can be discriminated based a result of mutually comparing a plurality of minimum values of gain control signals obtained in correspondence with a plurality of pieces of reference wobble frequency information.

Thus, this embodiment provides a medium discrimination device and a medium discrimination method capable of rapid and reliable discrimination of media by determining the types of media based on a plurality of minimum values of gain control signals obtained in correspondence with a plurality of pieces of reference wobble frequency information.

### Third Embodiment

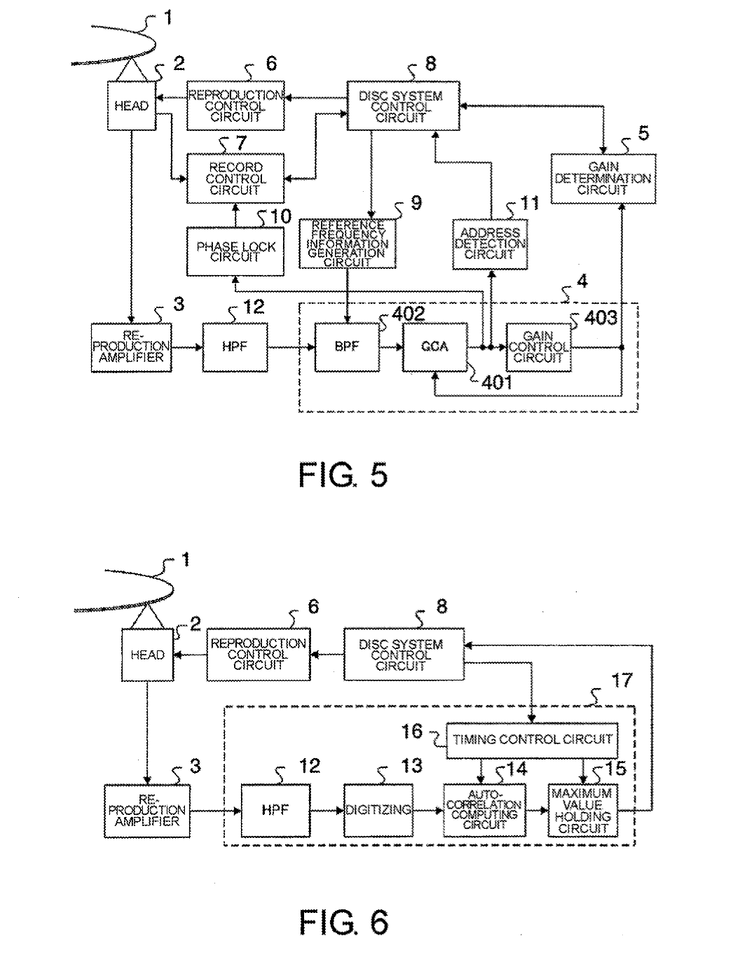

A third embodiment of this invention will be described in detail with reference to FIG. 5. This embodiment is different from the second embodiment in that configuration of the amplitude correction circuit for generating a gain control signal has been changed. FIG. 5 is a block diagram showing an optical disc recording/reproduction device according to the third embodiment. The optical disc recording/reproduction device of FIG. 5 is different from the optical disc memory/reproduction device of FIG. 4, in that a high-pass filter 12 is additionally provided. Signal processing is performed by passing a radial push-pull signal through a high-pass filter 12, a bandpass filter 402, a gain control amplifier 401, and a gain control circuit 403.

A signal input to the amplitude correction circuit 4 is firstly passed through the bandpass filter 402 and then through the gain control amplifier 401. The gain control circuit 403 controls the gain control signal such that the output amplitude of the gain control amplifier is kept constant. By arranging the bandpass filter before the gain control amplifier in this manner, the dynamic range of the gain control amplifier can be utilized more effectively. On the other hand, the amplitude of the reference wobble frequency component supplied to the bandpass filter becomes more apt to vary. In the example shown in FIG. 5, the high-pass filter 12 is provided between the reproduction amplifier and the amplitude correction circuit. Here again, the effect of reducing the dynamic range required for the amplitude correction circuit can be obtained, since this high-pass filter 12 removes gentle variation in the radial push-pull signal. The other circuit blocks shown in FIG. 5, which operate in the same manner as those in FIG. 4, will be easily understandable, and therefore detailed description thereof will be omitted.

The amplitude correction circuit 4 according to the third embodiment is configured such that a designated frequency component is extracted from a radial push-pull signal, and a wobble signal which has been corrected to allow the amplitude of the extracted frequency component to be kept substantially constant is generated. However, the third embodiment is completely the same as the second embodiment in that a wobble signal corrected to keep the amplitude of the frequency component constant is generated. Therefore, like the second embodiment, the third embodiment provides a medium discrimination device and a medium discrimination method capable of rapid and reliable discrimination.

Although this invention has been described in conjunction with a few preferred embodiments thereof, the invention is not limited to the foregoing embodiments but may be modified by those skilled in the art in various other manners within the scope of the appended claims.

This application is based upon and claims the benefit of priority from Japanese Patent Application No. 2008-025875, filed Feb. 6, 2008, the disclosure of which is incorporated herein in its entirety by reference.

1. A device for determining existence or non-existence of wobble, which determines whether or not an information track of an optical disc meanders at a predetermined frequency based on a radial push-pull signal, the device being characterized by comprising:
amplitude correction means for generating, from the radial push-pull signal, a wobble signal which has been corrected such that the amplitude of a predetermined frequency component is kept substantially constant, and for outputting a magnification for correcting the amplitude of the predetermined frequency component as a gain control signal; and
determination means for determining whether or not wobble exists based on the minimum value of the magnification indicated by the gain control signal.

2. The device for determining existence or non-existence of wobble as claimed in claim 1, characterized in that the amplitude correction means comprises:
a gain control amplifier for correcting the amplitude of the radial push-pull signal based on the gain control signal;
a bandpass filter for generating a wobble signal by extracting the predetermined frequency component from an output signal from the gain control amplifier; and
gain control means for generating a gain control signal based on the wobble signal.

3. The device for determining existence or non-existence of wobble as claimed in claim 1, characterized in that the determination means determines whether or not wobble exists by comparing the minimum value of the gain control signal with a predetermined reference value.

4. A medium discrimination device for discriminating types of optical discs based on a radial push-pull signal, the medium discrimination device being characterized by comprising:
reference frequency information generation means for switching and outputting reference wobble frequency information according to a plurality of different standards;
amplitude correction means for generating, from the radial push-pull signal, a wobble signal which has been corrected such that the amplitude of a frequency component designated by the reference wobble frequency information is kept substantially constant, and for outputting a magnification for correcting the amplitude of the designated frequency component, as a gain control signal; and
discrimination means for discriminating types of media based a plurality of minimum values of the gain control signals obtained for a plurality of pieces of reference wobble frequency information supplied by the reference frequency information generation means.

5. The medium discrimination device as claimed in claim 4, characterized in that the amplitude correction means comprises:
a gain control amplifier for correcting the amplitude of the radial push-pull signal based on the gain control signal;
a bandpass filter for generating a wobble signal by extracting the predetermined frequency component from an output signal of the gain control amplifier; and
gain control means for generating a gain control signal based on the wobble signal.

6. The medium discrimination device as claimed in claim 4, characterized in that the discrimination means discriminates types of media based on a result of comparing, with a predetermined reference value, the plurality of minimum values of the gain control signals obtained in correspondence with the plurality of pieces of reference wobble frequency information.

7. The medium discrimination device as claimed in claim 4, characterized in that the discrimination means discriminates types of media based on result of mutually comparing the plurality of minimum values of the gain control signals obtained in correspondence with the plurality of pieces of reference wobble frequency information.

8. A method of determining existence or non-existence of wobble, which determines whether or not an information track of an optical disc meanders at a predetermined frequency based on a radial push-pull signal, the method being characterized by comprising the steps of:
generating a wobble signal by correcting the amplitude of the radial push-pull signal based on a gain control signal and extracting a predetermined frequency component;
generating a gain control signal indicating such a correction magnification as to keep the amplitude of the wobble signal substantially constant; and
determining existence or non-existence wobble, based on the minimum value of the magnification indicated by the gain control signal.

9. The method of determining existence or non-existence of wobble as claimed in claim 8, characterized in that, in the step of existence or non-existence wobble, it is determined whether or not wobble exists by comparing the minimum value of the gain control signal with a predetermined reference value.

10. A medium discrimination method for discriminating types of optical discs based on a radial push-pull signal, the medium discrimination method being characterized by comprising the steps of:
generating reference frequency information by switching and outputting pieces of reference wobble frequency information according to a plurality of standards;
generating a wobble signal from the radial push-pull signal by correcting the amplitude of a frequency component designated by the reference wobble frequency information to be kept substantially constant, and extracting the designated frequency component;
generating a gain control signal indicating such a correction magnification as to keep the amplitude of the wobble signal substantially constant; and
determining the type of the medium based on a plurality of minimum values of gain control signals obtained in correspondence with a plurality of pieces of reference frequency information.

11. The medium discrimination method as claimed in claim 10, characterized in that, in the step of determining the type of the medium, the type of the medium is determined based on a result of comparing, with a predetermined reference value, a plurality of minimum values of the gain control signals obtained in correspondence with the plurality of pieces of reference wobble frequency information.

12. The medium discrimination method as claimed in claim 10, characterized in that, in the step of determining the type of the medium, the type of the medium is determined based on a result of mutually comparing a plurality of minimum values of the gain control signals obtained in correspondence with the plurality of pieces of reference wobble frequency information.
